(19) United States
(12) Patent Application Publication
(10) Pub. No.: US 2023/0161809 A1
(43) Pub. Date: May 25, 2023

(54) METHODS AND SYSTEMS FOR MODIFYING CONTENT SEARCHES

(71) Applicant: Comcast Cable Communications, LLC, Philadelphia, PA (US)

(72) Inventors: Scott A. ARMSTRONG, Philadelphia, PA (US); Arpit MATHUR, Philadelphia, PA (US); Arun RAVISANKAR, Philadelphia, PA (US)

(21) Appl. No.: 17/532,730

(22) Filed: Nov. 22, 2021

(51) Int. Cl. G06F 16/532; G06F 16/583

(52) U.S. Cl. CPC G06F 16/532; G06F 16/583

(57) ABSTRACT

A first computing device may receive a request for content. The request for content may be received from a second computing device. The content may comprise audio content, video content, and/or audio/video content. The computing device may determine a plurality of images. The plurality of images may be determined based on the request for content. A combined query image may be generated. The combined query image may comprise the plurality of images. The combined query image may be generated by the computing device.

### BACKGROUND

A number of ways exist to search for content. The content can take the form of live, linear content, video-on-demand content, audio-on-demand content, web-based content, and the like. However, a significant amount of content, both audio and video content, is now available to users and the amount continues to increase. As more content is made available to users, finding particular content that a specific user has an interest in can become more difficult due to a greater number of content items satisfying a particular search query. Once a particularly successful search query is identified and/or used by a user, the user may want to be able to recall the search query in order to share it with other users, or access it at a later time in order to find the particular content again. It may be difficult for the user to identify the string of text of a successful search query from other strings of text of unsuccessful search queries. In addition, it may be cumbersome to reproduce long search queries for resubmission as a search or for sharing via email, text message, or instant message with other users.

### SUMMARY

It is to be understood that both the following general description and the following detailed description are exemplary and explanatory only and are not restrictive. Methods and systems for modifying, sharing, and/or using content searches are described.

A combined image query may be created based on search query received from a computing device. The combined image query may contain a plurality of images associated with the search query that are combined into a single image. The combined image query may provide a visual indication of the contents of the search query. The combined image query may also include metadata that provides an indication of the search query.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system for modifying a request for content;

FIG. 2 shows an example block diagram for determining one or more words or phrases in the request for content;

FIG. 3 shows an example block diagram for associating one or more words or phrases in the request for content to an attribute of the plurality of attributes;

FIGS. 4A-D show example block diagrams for associating an image to one or more words or phrases in the request for content;

FIGS. 5A-E show example block diagrams for generating a combined query image;

FIG. 6 shows a flowchart of an example method for modifying the request for content;

FIG. 7 shows a flowchart of an example method for causing modification of the request for content;

FIG. 8 shows a flowchart of an example method for content searching; and

FIG. 9 shows a block diagram of an example system and computing device for modifying the request for content and conducting content searching.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

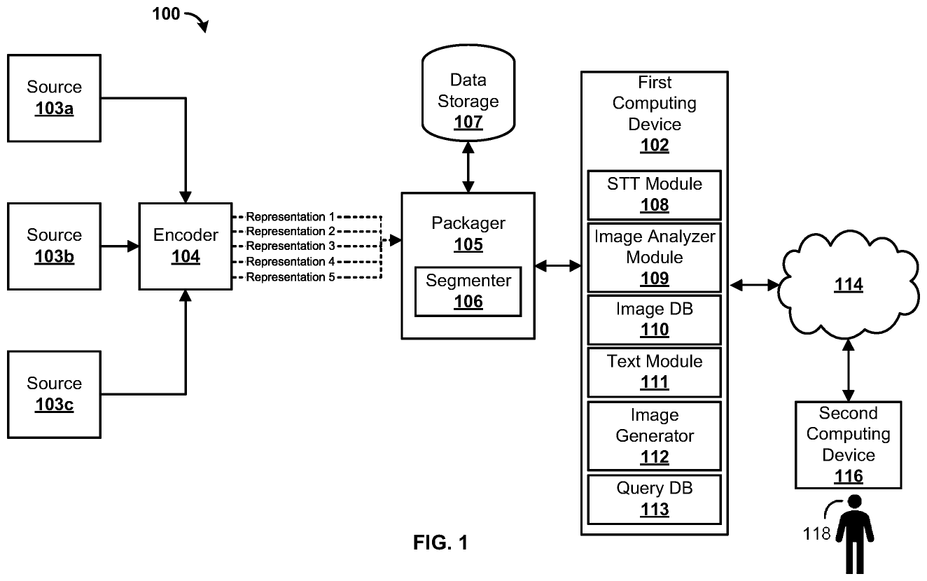

FIG. 1 shows an example system 100. The example system 100 may be configured for modifying a request for content. Although only certain devices and/or components are shown, the system 100 may comprise a variety of other devices and/or components that support a wide variety of network and/or communication functions, operations, protocols, content, services, and/or the like. The system 100 may include a plurality of computing devices/entities in communication via a network 114. The network 114 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 114 via a variety of transmission paths, including wireless paths (e.g., satellite paths, Wi-Fi paths, cellular paths, etc.) and terrestrial paths (e.g., wired paths, a direct feed source via a direct line, etc.). The network 114 may include public networks, private networks, wide area networks (e.g., Internet), local area networks, and/or the like. The network 114 may include a content access network, content distribution network, and/or the like. The network 114 may be configured to provide content from a variety of sources using a variety of network paths, protocols, devices, and/or the like. The content delivery network and/or content access network may be managed (e.g., deployed, serviced) by a, for example, a content provider, a service provider, and/or the like. The network 114 may deliver content items from a content source 103a-c to a second computing device 116 (e.g., a user device). The second computing device 116 may be a content/media player, a set-top box, a client device, a smart device, a mobile device, and the like.

The system 100 may include the one or more content sources 103a-c, each of which may be a server or other computing device. Each content source 103a-c or any other computing device may receive source streams for a plurality of content items. The source streams may be video content, audio content, web-based content, and/or audio/video content. The source streams may be live streams (e.g., a linear content stream) audio-on-demand streams, and/or video-on-demand (VOD) streams. Each content source 103a-c or any other computing device may receive source streams from an external server or device (e.g., a stream capture source, a data storage device, a media server, etc.). Each content source 103a-c or any other computing device may receive the source streams via a wired or a wireless network connection, such as the network 114 or another network (not shown).

Each content source 103a-c or any other computing device may send (e.g., provide, transmit, etc.) content (e.g., video, audio, web-based, audio/video, games, applications, or data) and/or content items (e.g., video, audio, streaming content, movies, shows/programs, etc.) to second computing devices (e.g., the second computing device 116). Each content source 103a-c or any other computing device may provide streaming media, such as live content, on-demand content (e.g., VOD), content recordings, and/or the like. Each content source 103a-c or any other computing device may be managed by a third-party, such as content providers, service providers, online content providers, over-the-top content providers, and/or the like. Each content source 103a-c or any other computing device may be configured to provide content items via the network 114. Content items may be accessed by one or more second computing devices 116 via applications, such as mobile applications, television applications, set-top box applications, gaming device applications, and/or the like. An application may be a custom application (e.g., by a content provider, for a specific device), a general content browser (e.g., a web browser), an electronic program guide, and/or the like.

Although three content sources 103a-c are shown in FIG. 1, this is not to be considered limiting. In accordance with the described techniques, the system 100 may comprise any number of content sources, each of which may receive any number of source streams.

The system 100 may include one or more encoders 104, such as a video encoder, a content encoder, etc. The encoder 104 or any other computing device may be configured to encode one or more source streams (e.g., received via one of the content sources 103a-c or another computing device) into a plurality of content items/streams at various bitrates (e.g., various representations). For example, the encoder 104 or any other computing device may be configured to encode the source stream for a content item at varying bitrates for corresponding representations (e.g., versions, such as Representations 1-5) of a content item for adaptive bitrate streaming. It is to be understood that FIG. 1 shows five representations for explanation purposes only, as the encoder 104 may be configured to encode the source stream into fewer or greater representations.

The system 100 may include a packager 105. The packager 105 or any other computing device may be configured to receive one or more content items/streams from the encoder 104 or any other computer device. The packager 105 or any other computing device may be configured to prepare content items/streams for distribution. For example, the packager 105 or any other computing device may be configured to convert encoded content items/streams into a plurality of content fragments. For example, the packager 105 may include a segmenter 106. The packager 105 may also include (or have access to) a data storage device 107. The segmenter 106 or any other computing device may divide a set of encoded streams into media/content segments. For example, the segmenter 106 or any other computing device may receive a target segment duration. The target duration may be, for example, approximately two thousand milliseconds or any other desired time or data allotment. The target segment duration may be a preset amount or received via user input. Alternately, the target segment duration may be dynamically determined based on properties of the encoded source stream or the packager 105. For example, if the target segment duration is two seconds, the segmenter 106 or any other computing device may process the incoming encoded streams and break the encoded streams into segments at key frame boundaries approximately two seconds apart. Further, if the encoded streams include separate video and audio streams, the segmenter 106 or any other computing device may generate the segments such that the video and audio streams are timecode aligned. Segments may alternately be referred to as “chunks.”

The packager 105 may be configured to support both multiplexed segments (video and audio data included in a single multiplexed stream) and non-multiplexed segments (video and audio data included in separate non-multiplexed streams). Further, in the case of MPEG-DASH, the packager 105 may be configured to support container formats in compliance with international standards organization base media file format (ISOBMFF), associated with a file extension “.m4s”), motion picture experts group 2 transport stream (MPEG-TS), extensible binary markup language (EBML), WebM, Matroska, or any combination thereof.

The packager 105 or any other computing device may be configured to provide content items/streams according to adaptive bitrate streaming. For example, the packager 105 or any other computing device may be configured to convert encoded content items/streams at various representations into one or more adaptive bitrate streaming formats, such as Apple HTTP Live Streaming (HLS), Microsoft Smooth Streaming, Adobe HTTP Dynamic Streaming (HDS), MPEG DASH, and/or the like. The packager 105 or any other computing device may pre-package content items/streams and/or provide packaging in real-time as content items/streams are requested by second computing devices, such as the second computing device 116.

The system 100 may include a first computing device 102. For example, the first computing device 102 may be or include a content server. For example, the first computing device 102 or any other computing device may be configured to receive requests for content, such as content items/streams. The request for content may be in the form of a request for a particular content item or a search query to identify one or more content items. The first computing device 102 or any other computing device may determine the information in the request for content, may determine one or more content items/streams that satisfy the request for content, may identify a location of a requested content item, and may send (or cause the sending of) the content item, or a portion thereof, to a device requesting the content, such as the second computing device 116 via the network 114 or another network. The first computing device 102 may comprise a Hypertext Transfer Protocol (HTTP) Origin server. The first computing device 102 may be configured to provide a communication session with a requesting device, such as the second computing device 116, based on HTTP, FTP, or other protocols. The first computing device 102 (e.g., the content server) may be one of a plurality of content servers distributed across the system 100. The first computing device 102 may be located in a region proximate to the second computing device 116 and a user 118 associated with the second computing device 116. A request for a content stream/item from the second computing device 116 may be directed to the first computing device 102 (e.g., due to the location of the second computing device 116 and/or the first computing device 102 and/or network conditions). The first computing device 102 may be configured to deliver, or cause delivery of, content streams/items to the second computing device 116 in a specific format requested by or determined for the second computing device 116. The first computing device 102 may be configured to provide the second computing device 116 with a manifest file (e.g., or other index file describing portions of the content) corresponding to a content stream/item. The first computing device 102 may be configured to provide streaming content (e.g., unicast, multicast) to the second computing device 116. The first computing device 102 may be configured to provide a file transfer and/or the like to the second computing device 116.

The first computing device 102 or any other computing device may receive the request for content that may be or may include a search query. The first computing device 102 or any other computing device may be configured to generate a query image (e.g., a combined query image) based on all or a portion of the request for content. For example, the combined query image may be a single image that may include one or multiple embedded images associated with the original request for content, such that the imagery of the one or more embedded images in the combined query image provides a visual indication of the contents of the request for content associated with the combined query image.

The first computing device 102 may evaluate the received request for content to determine one or more elements of the request for content, For example, elements of the request for content may include one or more of, text content (e.g., at least one word or phrase), audio content, video input, images, icons, or emojis. The first computing device 102 may convert each or a portion of the elements of the request for content into text content (e.g., one or more words or phrases). For example, the first computing device 102 may include a speech-to-text module 108. The first computing device 102 may receive the audio content and convert the audio content into text. For example, the first computing device 102 or any other computing device may use natural language processing to identify the one or more words or phrases in the audio content.

For example, the first computing device 102 or any other computing device may include an image analyzer module 109. The image analyzer module 109 or any other computing device may evaluate any images, icons, video content, or emojis in the request for content to determine the text content (e.g., one or more words or phrases) associated with each image, icon, video content, or emoji in the request for content. For example, the first computing device 102 may determine descriptive text associated with the particular image, icon, video content, or emoji in the title or metadata of the file associated with the image, icon, video content, or emoji. For example, the first computing device 102 may conduct a search (e.g., an internal or external search) to identify a textual description of the particular image, icon, video content, or emoji.

For example, the first computing device 102 or any other computing device may also include a text module 111. The text module 111 or any other computing device may evaluate the text of the request for content (e.g., one or both of the original text in the request for content or the converted text (e.g., derived from the audio content, video content, emoji, icon, and/or image)) to identify one or more words or phrases within the request for content. The first computing device 102 may also evaluate each word or phrase of the request for content to determine which words or phrases are associated with an image attribute. For example, the first computing device 102 may compare each word or phrase (and/or each audio content, video content, image, icon, or emoji) in the request for content to each attribute to determine which of the plurality of words or phrases (and/or each audio content, video content, image, icon, or emoji) in the request for content are associated with (e.g., fall within the definition of or would be included in the description of) which attributes. For example, the first computing device 102 may compare each of the one or more words or phrases (e.g., one or both of the original text in the request for content or the converted text (e.g., derived from the audio content, video content, emoji, icon, and/or image)) in the request for content to each attribute of the plurality of attributes to determine if the particular word or phrase is associated with (e.g., falls within the definition of or would be included in the description of) the attribute.

The first computing device 102 may also determine a priority level or position for one or more of the plurality of attributes. For example, all or a portion of the plurality of attributes may be assigned a priority level or position with respect to other ones of the plurality of attributes. The priority level assigned to the respective one of the plurality of attributes may indicate a layer of a plurality of layers of the combined query image for placement of an associated image that corresponds to the portion of the one or more words or phrases in the request for content associated with the particular attribute. For example, the priority level of an attribute may be used to determine how and/or where to position an image associated with the particular attribute.

For example, an image associated with a higher priority attribute may be positioned higher in a stack of images (or a layer closer to the front) for the combined query image than an image associated with a lower priority attribute. Having a higher priority and being higher in the stack of images and/or on a layer closer to the front of the combined query image may potentially result in the image being less covered by other images incorporated into the combined query image. For example, an image associated with a higher priority attribute may be more centrally positioned within a combined query image than an image associated with a lower priority attribute.

For example, the area for a combined query image may be divided into a grid of image positions within a boundary area for the combined query image and for each of the images identified based on the request for content. Each grid area in the grid of image positions within the boundary area of the combined query image may be associated with a particular priority level of a plurality of priority levels for the attributes. For example, the center of the grid for the combined query image may be associated with the highest priority attribute for which at least one of the words or phrases in the request for content is associated. Other areas within the grid may include top left quadrant of the boundary area, top right quadrant of the boundary area, bottom left quadrant of the boundary area, and bottom right quadrant of the boundary area for the combined query image. However, these grid areas are for example purposes only as the grid layout and the priority given to each grid area may be presented in a number of other ways. The priority assigned to each attribute may be fixed or adjustable.

The priority assigned to each attribute may be preset and/or provided by the user 118 and received from the second computing device 116 associated with the user 118. For example, the attributes may include one or more of the following categories, subject types, or general classifications: “actor,” “activity,” “channel,” “year” or “period,” “genre,” “location,” “emotion,” and/or “tv show/movie”. The listed attributes are for example purposes only. Additional attributes or subject types may be used in addition to or in replacement of one or more of the attributes or subject types described herein.

The first computing device 102 may also determine an image associated with each word or phrase or a portion of the words or phrase that are also associated with one of the attributes. For example, the first computing device 102 may conduct an internal search by evaluating images in first computing device 102 to identify one or more images that match or are otherwise associated with a particular word or phrase in the request for content. For example, the first computing device 102 may include a plurality of images across a range of attributes and may include descriptive information providing a textual description of the contents of each image to assist with matching an image in the first computing device 102 to the word or phrase from the request for content. For example, the first computing device 102 may conduct an external search. In the external search, the first computing device 102 may provide the word or phrase associated with an attribute to a third-party search engine to identify the one or more images associated with the particular word or phrase.

The first computing device 102 or any other computing device may also include an image generator 112. The image generator 112 or any other computing device may be configured to receive a plurality of images associated with one or more of the words and/or phrases in the request for content and generate or create a combined query image. The combined query image may comprise a single image that includes one or multiple embedded images associated with the original request for content, such that the imagery of the one or more embedded images in the combined query image provides a visual indication of the contents of the request for content associated with the combined query image.

For example, the first computing device 102 may receive a plurality of images. Each of the images may be selected based on one or more of the words or phrases in or derived from (e.g., derived from an image, emoji, audio content, and/or video content) the request for content. One or more of the plurality of images may be associated with a priority level for placement or positioning of the corresponding image within the boundary of the combined query image. For example, one or more of the words or phrases in the request for content may be associated with a particular attribute, and the attribute may be associated with or assigned a priority level. The first computing device 102 may position the image associated with the one or more words or phrases associated with each particular attribute based on the associated priority level for the particular attribute.

For example, the image associated with the highest priority attribute may be positioned on the top layer of the combined query image, the image associated with the second highest priority attribute may be positioned on the second layer, immediately below the top layer image, and so on. For example, the image associated with the lowest priority attribute may be positioned on the bottom layer of the combined query image, or the lowest layer of the images associated with one of the plurality of attributes (e.g., when images not associated with any of the attributes are also included in the combined query image).

For example, the first computing device 102 may position an image associated with the highest priority level attribute that is associated with one or more of the words or phrases in the request for content at the center of the combined query image. For example, the first computing device 102 may position images associated with lesser priority attributes at other predetermined or user-assigned locations within the boundary of the combined query image with no or some overlap with other images in the combined query image. The priority level for each of the attributes may be preset and/or may be set or modified by the user via another computing device (e.g., the second computing device 116).

The first computing device 102 may also be configured to insert metadata into the file of the combined query image. For example, the metadata may comprise all or a portion of the request for content (e.g., the search query). For example, the first computing device 102 may append the search query or the request for content into the metadata of the file of the combined query image, such as in the image description or title of the file. The created combined query image may be stored in the first computing device 102, such as in a query database 113, or any other computing device or may be sent or otherwise transmitted to another computing device (e.g., the second computing device 116 or any other computing device via the network 114, or another network), for storage of the combined query image at the other computing device.

In an example operation, the user 118 may send, via the second computing device 116 or any other computing device, the request for content. For example, the request for content may be a search query. For example, the search query may be “show me Joe Smith sports movies.” The request for content may be received by the first computing device 102 or any other computing device from the second computing device 116 or any other computing device via the network 114.

The first computing device 102 or any other computing device may evaluate the text in the request for content (e.g., “show me Joe Smith sports movies) to identify the one or more words or phrases within the request for content. For example, the first computing device 102 may separate the request for content into the following groups of words or phrases: “show me,” “Joe Smith,” “sports,” and “movies.” The first computing device 102 may compare each of the words or phrases to one or more of the plurality of attributes to determine if any of the words or phrases are associated with one of the plurality of attributes. For example, the first computing device 102 may determine if the particular word or phrase is associated with (e.g., falls within the definition of or would be included in the description of or the grouping of) the attribute. For example, “Los Angeles,” “Russia,” and “school” would all be included in the attribute “location” but “football” would not. For example, the plurality of attributes may include “actor,” “activity,” “channel,” “year,” “genre,” “location,” “emotion,” and “tv show/movie.” The first computing device 102 may determine that “show me” is not associated with any of the attributes. The first computing device 102 may determine that “Joe Smith” is associated with the “actor” attribute. The first computing device 102 may determine that “sports” is associated with the “genre” attribute. The first computing device 102 may determine that “movies” is associated with the “tv show/movie” attribute.

The first computing device 102 may also determine a priority level or position for one or more of the plurality of attributes for which at least one word or phrase of the request for content is associated. For example, the priority level for an attribute may be associated with a layer level to place an image associated with a word or phrase associated with the particular attribute. For example, the plurality of attributes may be prioritized as follows (from highest priority to lowest priority): “actor,” “activity,” “channel,” “year,” “genre,” “location,” “emotion,” and “tv show/movie.” The first computing device 102 may determine that none of the words or phrases in the request for content are associated with the attributes “activity,” “channel,” “year,” “location,” or “emotion.” The first computing device 102 may determine that at least one word or phrase of the request for content is associated with the attributes “actor,” “genre,” and “tv show/movie.” The first computing device 102 may determine that an image associated with the word or phrase associated with the attribute “actor” will have the highest priority, that another image associated with the word or phrase associated with the attribute “genre” will have the second highest priority, and that another image associated with the word or phrase associated with the attribute “tv show/movie” will have the third highest priority. The first computing device 102 may determine that the highest priority image (e.g., the image associated with “actor”) will be positioned on a top layer of a plurality of layers for the combined query image, that the second highest priority image (e.g., the image associated with “genre”) will be positioned on a second layer, immediately below the top layer, for the combined query image, and that the third highest priority image (e.g., the image associated with “tv show/movie”) will be positioned on a third layer, immediately below the second layer, for the combined query image. In this example, an image may not be determined for the phrase “show me” since it was not associated with any of the plurality of attributes. However, in another example, images associated with a word or phrase that is not associated with one of the plurality of attributes may be given a lower priority (and, for example, a lower layer position for the combined image query) than the words or phrases associated with one of the plurality of attributes.

The first computing device 102 may also determine an image associated with each of “Joe Smith,” “sports,” and “movies” to be used in the combined query image. For example, the first computing device 102 may conduct an internal or external search. For example, the first computing device 102 may conduct an internal search by comparing each of the words or phrases to images in the first computing device 102 or any other computing device to identify one or more images that match or are otherwise associated with the particular word or phrase in the request for content. For example, the first computing device 102 may conduct an external search by providing the particular word or phrase to the third-party search engine to identify the one or more images associated with the particular word or phrase. For example, the first computing device 102 (by either an internal or external search) may identify an image of Joe Smith as the image associated with “Joe Smith,” an image of a football, basketball, and baseball as the image associated with “sports,” and an image of a movie reel as the image associated with “movies.”

The first computing device 102 or any other computing device may access the images associated with “Joe Smith,” “sports,” and “movies” and may create or generate the combined query image. For example, the first computing device 102 may begin with a boundary area for the combined image query. The first computing device 102 may retrieve the lowest priority image (e.g., the image of the movie reel), based on the lowest priority associated attribute “tv show/movie,” and insert the image of the movie reel within the boundary area for the combined query image at a bottom or third layer. The first computing device 102 may move, reorient, rotate, resize, and/or modify the color of the image of the movie reel. The first computing device 102 may retrieve the next lowest priority image (e.g., the image of the football, basketball, and baseball), based on the next lowest priority associated attribute “genre,” and insert the image of the football, basketball, and baseball within the boundary area for the combined query image at a second layer that is above the bottom or third layer. The first computing device 102 may move, reorient, rotate, resize, and/or modify the color of one or both of the image of the movie reel or the image of the football, basketball, and baseball to fit within the boundary area, and/or reduce the overlap between the two images. The first computing device 102 may retrieve the highest priority image (e.g., the image of Joe Smith), based on the highest priority associated attribute “actor,” and insert the image of Joe Smith within the boundary area for the combined query image at a top or first layer that is above the second and third layers. The first computing device 102 may move, reorient, rotate, resize, and/or modify the color of one or more of the image of the movie reel, the image of the football, basketball, and baseball, or the image of Joe Smith to fit within the boundary area, and/or reduce the overlap between the three images. The first computing device 102 may combine the three images into a single combined query image. For example, the first computing device 102 may “flatten” the three layers of images into the single combined query image.

The first computing device 102 may append metadata to the combined query image. For example, the first computing device 102 may append metadata that comprises the request for content “show me Joe Smith sports movies” to a title or description of the combined query image. The first computing device 102 may store the combined query image in the first computing device 102 (e.g., the query database 113) or any other computing device. The combined query image may be associated with one or more identifiers of the user 118 (e.g., a user name, an email address, a phone number, and/or an address associated with the second computing device 116, such as a MAC address, a network address, etc.). The first computing device 102 may send or transmit the combined query image to the second computing device 116 via the network 114.

The second computing device 116 or any other computing device may receive the combined query image and store the combined query image in memory of the second computing device 116. The second computing device 116 may store the combined query image for subsequent use as the request for content. For example, the user 118, via the second computing device 116, may subsequently send the combined query image to the first computing device 102 or another computing device to represent the search query for content (e.g., the request for content). For example, the user 118, via the second computing device 116, may subsequently send (e.g., via a Short Message Service (SMS) message, a Multimedia Messaging Service (MMS) message, an instant message, an email, a HyperText Transmission Protocol (HTTP) communication, or any other form of electronic message) the combined query image to another computing device (e.g., another user device). The other computing device (e.g., another user device) may be associated with the user 118 or an unrelated user. The user 118, or the other user receiving the combined query image at the other computing device, via the second computing device 116, may subsequently send the combined query image as the request for content to also search for Joe Smith sports movies. In such a manner, the user 118, via the second computing device 116, may share preferred search queries in the form of a single image with other users. Further, the imagery of the three embedded images in the combined query image may provide a visual indication of the contents of the request for content (e.g., “show me Joe Smith sports movies”) associated with the combined query image.

While the example embodiment of FIG. 1 describes the first computing device 102 including the speech-to-text module 108, the image analyzer module 109, the image database 110, the text module 111, the image generator 112, and the query database 113, this is just for example purposes only. In other examples, one or more of these elements may be in one or more other computing devices and the first computing device 102 (e.g., the content server) may send the data to those respective one or more other computing devices for the described analysis.

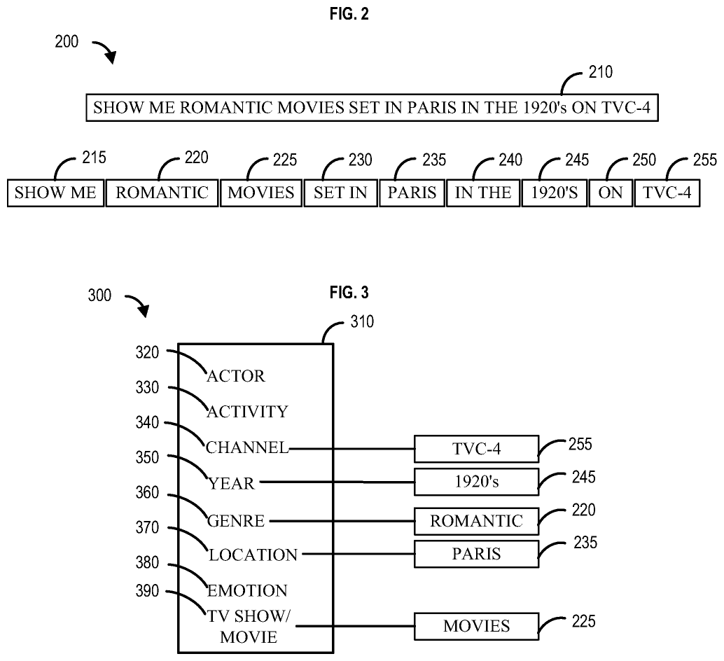

FIG. 2 shows an example block diagram 200 for determining one or more words or phrases in a request for content 210. The methods described in FIG. 2 may be completed by a computing device (e.g., the first computing device 102 or any other computing device). The first computing device 102 may determine the one or more words or phrases in the request for content 210. For example, the first computing device 102 may determine the one or more words or phrase in the request for content 210 that will be evaluated for associated images.

The request for content 210 may be in the form of a search query. While the example request for content 210 of FIG. 2 shows only text in the search query of the request for content 210, in other examples, the request for content 210 may comprise one or more query elements, such as text (e.g., one or more words and/or phrases), audio content (e.g., speech), video content, one or more images, icons, or emojis. The request for content 210 may be received by the first computing device 102 from another computing device (e.g., the second computing device 116, such as the user device, or any other computing device). For example, the request for content 210 may be received by the first computing device 102 via the network 114 or another network.

The first computing device 102 may parse or separate the request for content 210 into multiple parts. For example, the first computing device 102 may separate each type of element (e.g., text (e.g., words and/or phrases), audio content, video content, one or more images, icons, or emojis) in the request for content 210 from each other type of element. For example, the first computing device 102 may convert each non-text element (e.g., audio content, video content, image, icon, or emoji) of the request for content 210 into text. For example, if the request for content 210 includes audio content (e.g., a voice recording), the first computing device 102 (e.g., the speech-to-text module 108 or any other portion) may use speech-to-text software to convert the audio content into text. For example, if the request for content 210 includes video content, images, icons, or emojis, the first computing device 102 (e.g., the image analyzer module 109) may determine text associated with the video content, image, icon, or emoji. For example, the image analyzer module 109 may analyze the image file for the video content, image, icon, or emoji and may determine metadata that describes the video content, image, icon, or emoji within the image file. The text-based description of the video content, image, icon, or emoji within the metadata of the image file may be used as the converted text for the video content, image, icon, or emoji. For example, if the video content, image, icon, or emoji does not include metadata that provides a text-based description of the video content, image, icon, or emoji, the image analyzer module 109 may conduct an internal or external image search to determine a textual description of the video content, image, icon, or emoji. For example, if the request for content 210 includes one or more emojis, the first computing device 102 may evaluate the emoji and determine the text-based description associated with the emoji.

The first computing device 102 (e.g., the text module 111 or any other portion) may evaluate the text portion of the request for content 210 and parse or separate the text portion of the request for content 210 into one or more words or phrases 215-255. The first computing device 102 may also evaluate the determined text (e.g., the converted text (e.g., derived from the audio content, video content, emoji, icon, and/or image)) for each of the non-text elements of the request for content 210 to determine if any determined text for a non-text element should be separated into one or more words or phrases 215-255.

For example, the request for content 210 may include the following search query: “Show me romantic movies set in Paris in the 1920's on TVC-4.” The text of the request for content 210 may be been received completely as text or may have included any one or more of text, audio content, video content, images, icons, and/or emojis that were converted to text as described above. The first computing device 102 may separate the request for content 210 into one or more words or phrases 215-255. For example, the first computing device 102 may separate the request for content 210 into the following words and phrases: “show me” 215, “romantic” 220, “movies” 225, “set in” 230, “Paris” 235, “in the” 240, “1920's” 245, “on” 250, and “TVC-4” 255.

FIG. 3 shows an example block diagram 300 for associating one or more words or phrases in the request for content 210 (of FIG. 2) to a plurality of attributes 310. The methods described in FIG. 3 may be completed by a computing device (e.g., the first computing device 102 or any other computing device). For example, the first computing device 102 (e.g., the text module 111 or any other portion) may compare each word or phrase 215-255 (and/or each audio content, video content, image, icon, or emoji) in the request for content 210 to each attribute 310 to determine which of the plurality of words or phrases 215-255 (and/or each audio content, video content, image, icon, or emoji) in the request for content 210 are associated with (e.g., fall within the definition of or would be included in the description of or the grouping of) which one of the plurality of attributes 310. For example, the first computing device 102 may compare each of the one or more words or phrases 215-255 (e.g., one or both of the original text in the request for content 210 or the converted text (e.g., derived from the audio content, video content, emoji, icon, and/or image)) in the request for content 210 to each attribute 320-390 of the plurality of attributes 310 to determine if the particular word or phrase 215-255 is associated with (e.g., falls within the definition of or would be included in the description of or the grouping of) the attribute 320-390. For example, one or more words or phrases 215-255 of the request for content 210 may be associated with each particular attribute 320-390. For example, if more than one word or phrase 215-255 is associated with a particular attribute 320-390, then the first computing device 102 may determine images for each of the plurality of words or phrases 215-255 associated with the particular attribute 320-390.

For example, all or a portion of the plurality of attributes 310 may be assigned a priority level with respect to other ones of the plurality of attributes 310. For example, the priority level assigned to the respective one of the plurality of attributes 310 may indicate a layer of a plurality of layers of the combined query image for placement of an associated image that corresponds to the portion of the one or more words or phrases 215-255 in the request for content 210 associated with the particular attribute 320-390. For example, the image associated with the highest priority attribute (e.g., one of the attributes 320-390) of the plurality of attributes 310, may be positioned on the top layer of the combined query image, the image associated with the second highest priority attribute (e.g., one of the attributes 320-390) of the plurality of attributes 310 may be positioned on the second layer, immediately below the top layer image, and so on. For example, the image associated with the lowest priority attribute (e.g., one of the attributes 320-390) may be positioned on the bottom layer of the combined query image, or the lowest layer of the images associated with one of the plurality of attributes 310 when images not associated with any of the attributes (e.g., one of the attributes 320-390) are also included in the combined query image.

For example, the priority level assigned to the respective one or more of the plurality of attributes 310 may indicate a position (e.g., lateral, vertical, coordinates, etc.) to place the associated image that corresponds to the portion of the one or more words or phrases 215-255 in the request for content 210 associated with the particular attribute 320-390 within the combined query image. For example, the highest priority level attribute (e.g., one of the attributes 320-390) that is associated with one or more of the words or phrases 215-255 in the request for content 210 (e.g., “TVC-4” 255 associated with the channel 340) may be placed at the center of the combined query image. Lesser priority attributes (e.g., 350-370 and 390) may be positioned at other locations within the area of the combined query image with no or some overlap with other images in the combined query image.

For example, the area for the combined query image may be divided into a grid of image positions within a boundary area for the combined query image and for each of the images identified based on the request for content. Each grid area in the grid of image positions within the boundary area of the combined query image may be associated with a particular priority level of a plurality of priority levels for the attributes 320-390. For example, the center of the grid for the combined query image may be associated with the highest priority attribute (e.g., one of the attributes 320-390) for which at least one of the words or phrases 215-255 in the request for content 210 is associated. Other areas within the grid may include top left quadrant of the boundary area, top right quadrant of the boundary area, bottom left quadrant of the boundary area, and bottom right quadrant of the boundary area for the combined query image. However, these grid areas are for example purposes only as the grid layout and the priority given to each grid area may be presented in a number of other ways.

For example, the priority level assigned to the respective one or more of the plurality of attributes 310 may indicate an amount of the image that corresponds to the portion of the one or more words or phrases 215-255 in the request for content 210 associated with the particular attribute (e.g., one of the attributes 320-390) that must be viewable in the combined query image. For example, the priority level assigned to the respective one or more of the plurality of attributes 310 may indicate that the image that corresponds to the portion of the one or more words or phrases 215-255 in the request for content 210 associated with the particular attribute (e.g., one of the attributes 320-390) must have a greater percentage viewable in the combined query image than a corresponding image associated with another attribute 320-390 having a lesser priority level. The priority level may be preset for each or a portion of the one or more attributes 320-390 and/or may be set or modified by the user 118 via a computing device (e.g., the second computing device 116).

In the example of FIG. 2, the request for content 210 may include the following: “Show me romantic movies set in Paris in the 1920's on TVC-4.” As discussed above with respect to FIG. 2, the first computing device 102 may parse the request for content 210 into the following words and phrases: “show me” 215, “romantic” 220, “movies” 225, “set in” 230, “Paris” 235, “in the” 240, “1920's” 245, “on” 250, and “TVC-4” 255. The plurality of attributes 310 may include the following subject types (in priority order): “actor” 320, “activity” 330, “channel” 340, “year” or “period” 350, “genre” 360, “location” 370, “emotion” 380, and “tv show/movie” 390. The provided subject types or attributes are for example purposes only. Additional attributes or subject types may be used in addition to or in replacement of one or more of the attributes or subject types described herein.

For example, “actor” 320 may be the attribute with the highest priority setting, “activity” 330 may be the attribute with the second highest priority setting, “channel” 340 may be the attribute with the third highest priority setting, “year” 350 may be the attribute with the fourth highest priority setting, “genre” 360 may be the attribute with the fifth highest priority setting, “location” 370 may be the attribute with the sixth highest priority setting, “emotion” 380 may be the attribute with the seventh highest priority setting, and “tv show/movie” 390 may be the attribute with the eighth highest priority setting. Additional attributes and/or the elimination of some listed attributes may be provided for in a plurality of attributes in other examples. As discussed herein, the priority and types of attributes may be a preset feature or provided or modified by a user 118 via another computing device (e.g., the second computing device 116).

The first computing device 102 may determine the one or more words or phrases 215-255 (or optionally images or emojis) in the request for content 210 that are associated with the particular attributes 320-390. For example, the first computing device 102 may determine that there are no words or phrases 215-255 (or optionally images or emojis) in the request for content 210 that are associated with the attributes actor 320, activity 330, and emotion 340. The first computing device 102 may determine that the phrase “TVC-4” 255 is associated with (e.g., falls within the subject matter of) the attribute channel 340. The first computing device 102 may determine that the word “1920's” 245 is associated with (e.g., falls within the subject matter of) the attribute year 350. The first computing device 102 may determine that the word “romantic” 220 is associated with (e.g., falls within the subject matter of) the attribute genre 360. The first computing device 102 may determine that the word “Paris” 235 is associated with (e.g., falls within the subject matter of) the attribute location 370. The first computing device 102 may determine that the word “movies” 225 is associated with (e.g., falls within the subject matter of) the attribute tv show/movie 390. The remaining portions of the request for content 210, “show me” 215, “set in” 230, “in the” 240, and “on” 250 may be determined by the first computing device 102 to not be associated with any attribute 320-390 of the plurality of attributes 310.

The first computing device 102 may determine to not seek images associated with these words or phrases 210, 215, 230, 240, and 250 for the combined query image. Alternatively, the first computing device 102 may determine to seek images for one or more of these words or phrases 210, 215, 230, 240, and 250 and the priority of the particular word or phrase may be null or less than the lowest priority attribute (e.g., attribute “tv show/movie” 390) for which the word or phrase (e.g., “movies” 225) in the request for content 210 was associated.

The first computing device 102 may determine that the attribute “channel” 340 is the highest priority attribute for which the word or phrase 255 in the request for content 210 was associated. The first computing device 102 may determine that the attribute “year” 350 is the second highest priority attribute for which the word or phrase 245 in the request for content 210 was associated. The first computing device 102 may determine that the attribute “genre” 360 is the third highest priority attribute for which the word or phrase 220 in the request for content 210 was associated. The first computing device 102 may determine that the attribute “location” 370 is the fourth highest priority attribute for which the word or phrase 235 in the request for content 210 was associated. The first computing device 102 may determine that the attribute “tv show/movie” 390 is the fifth highest priority attribute for which the word or phrase 225 in the request for content 210 was associated.

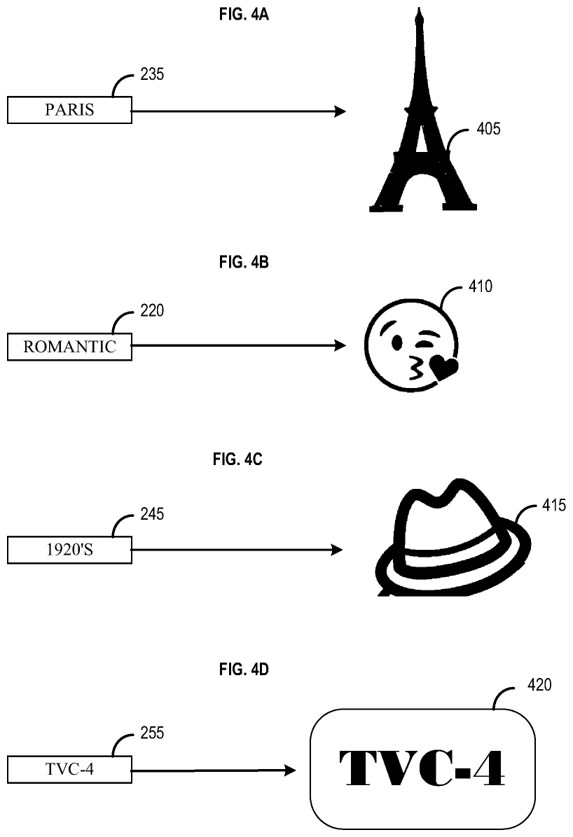

FIGS. 4A-D show block diagrams of an example method for associating an image to one or more words or phrases 215-255 in the request for content 210. The methods described in FIGS. 4A-D may be completed by a computing device (e.g., the first computing device 102 or any other computing device). For example, the first computing device 102 may search for, identify and/or otherwise associate an image to one or more of the words or phrases 215-255 in the request for content 210. For example, the first computing device 102 may search for, identify and/or otherwise associate an image to one or more of the words or phrases 215-255 in the request for content 210. For example, the plurality of images may be associated with the request for content 210. For example, each of the plurality of images may be associated with at least a portion of the request for content 210.

For example, the first computing device 102 may determine an image to associate with each of the one or more words or phrases 215-255 associated with one of the plurality of attributes 310. For example, the first computing device 102 may determine an image to associate with a portion of the words or phrases 215-255 associated with one of the plurality of attributes 310. For example, the first computing device 102 may determine an image to associate with one or more of the one or more words or phrases 215-255 in the request for content 210 that are not associated with (e.g., does not fall within the definition of or would not be included in the description of or the grouping of) any of the plurality of attributes 310. For example, the first computing device 102 may determine an image to associate with a particular word or phrase 215-255 based on an internal (e.g. to the first computing device 102) or external (e.g., to the first computing device 102) image search.

For example, in an internal image search, the first computing device 102 may compare each word or phrase 215-255 in the request for content 210 to a library of stored images (e.g., stored in the first computing device 102). For example, the first computing device 102 may identify and select a matching image or closest matching image from a plurality of possible matching images in the first computing device 102. For example, each image in the first computing device 102 may include a textual description of the corresponding image. For example, the textual description for each corresponding image may be included in the metadata for the respective image or otherwise associated with the respective image (e.g., table, title of image, etc.). The first computing device 102 may compare the corresponding word or phrase 215-255 in the request for content 210 to the textual description for each image in the first computing device 102 to identify the one or more matching images. For example, the matching one or more images may be determined based on a threshold percentage of words in the respective word or phrase 215-255 matching the textual description of the corresponding image being satisfied. The image selected to be associated with the respective word or phrase 215-255 from the request for content 210 may be the image with the highest percentage match. If multiple images match (e.g., match the same percentage of) the particular word or phrase 215-255 from the request for content 210, any of the matching images (e.g., images matching the same level or percentage of the word or phrase from the request for content 210) may be selected and associated with the particular word or phrase 215-255 from the request for content 210.

For example, in an external image search, the first computing device 102 may submit a search query comprising the particular word or phrase of the one or more words or phrases 215-255 from the request for content 210 to a third-party search module or engine via a network (e.g., the network 114). The first computing device 102 may receive, via the network 114, one or more image results from the third-party search engine. The first computing device 102 may select one or more of the image results to be associated with the particular word or phrase 215-255 from the request for content 210. For example, the first computing device 102 may select the first image result to associate with the particular word or phrase 215-255 from the request for content 210. For example, the first computing device 102 may select an image result from the one or more image results that best matches the context of the request for content 210 or is properly sized and shaped for the combined query image.

With reference to the earlier example, as shown in FIG. 4A, the first computing device 102 may determine a first image 405 associated with the word “Paris” 235, which is associated with the attribute “location” 370 (of FIG. 3). For example, the first image 405 may comprise a famous building associated with the location (e.g., the Eifel Tower, the Louvre, Notre Dame Cathedral, etc.), a textual representation of the location, famous people from the location, foods associated with the location, sports associated with the location, etc. For example, as shown in FIG. 4B, the first computing device 102 may determine a second image 410 associated with the word “romantic” 220, which is associated with the attribute “genre” 360. For example, the second image 410 may comprise an emoji kissing with a heart, a heart, and/or other images associated with the romance genre. For example, as shown in FIG. 4C, the first computing device 102 may determine a third image 415 associated with the word “1920's” 245, which is associated with the attribute “year” 350. For example, the third image 415 may comprise a graphical representation of the “1920's,” such as an item associated with the “1920's” (e.g., a style of hat or clothing, or a product or service available during that year or time period), a designation of the “1920's” (e.g., a textual representation of the 1920's, a nickname for that time period, such as the “roaring twenties,” etc.), people or characters associated with the “1920's” (e.g., famous people, presidents, sports figures, etc.), and/or a graphical adjustments to the particular image and/or the entire combined image query that is associated with the “1920's” (e.g., black and white, dimmed (associated with industrialization), etc.). For example, as shown in FIG. 4D, the first computing device 102 may determine a fourth image 420 associated with the phrase “TVC-4” 255, which is associated with the attribute “channel” 340. For example, the fourth image 420 may comprise a logo for “TVC-4”, the number 4, or another image associated with “TVC-4”.

For example, the first computing device 102 may not determine an image associated with the word “movies” 225 which is associated with the attribute “tv show/movie” 390. For example, the first computing device 102 may determine that a quantity of images threshold exists for the combined query image and may compare the quantity of potential images in the combined query image (e.g., based on the number of attributes 320-390 associated with one or more words or phrases 215-255 in the request for content 210 and/or additional words or phrases 215-255 in the request for content 210 for which images may be identified) to the quantity of images threshold to determine if the quantity of images threshold is satisfied. For example, if the quantity of images threshold is four and the example above includes five attributes (e.g., channel 340, year 350, genre 360, location 370, and tv show/movie 390) associated with one or more words or phrases 215-255 of the request for content 210, the first computing device 102 may determine that the quantity of images threshold is satisfied (e.g., the quantity of images is greater than or greater than or equal to the quantity of images threshold). The first computing device 102 may limit or reduce the quantity of images to be included in the combined query image to an amount that does not satisfy the quantity of images threshold. For example, the first computing device 102 may limit the quantity of images to be included in the combined query image to the quantity of images that does not satisfy the quantity of images threshold and is associated with the higher priority attributes 320-390 (e.g., the images associated with the lower priority attributes 320-390 or with words or phrases 215-255 in the request for content 210 that are not associated with an attribute 320-390 would not be included in the combined query image). In the example discussed above, with a quantity of images threshold of four, the images 405-420 associated with the attributes channel 340, year 350, genre 360, and location 370 would be included in the combined query image but an image associated with the attribute tv show/movie 390 would not be included in the combined query image because the attribute tv show/movie 390 has a lower priority level than each of attributes channel 340, year 350, genre 360, and location 370 and the quantity of images threshold is already satisfied.

For example, the first computing device 102 may not determine an image associated with the words or phrases “show me” 215, “set in” 230, “in the” 240, and “on” 250 from the request for content 210, because these words are not associated with any one of the plurality of attributes 310, because the quantity of images threshold has been satisfied, and/or because the terms are tying words and not descriptive, such that corresponding images evoking those terms are unlikely to be identified.

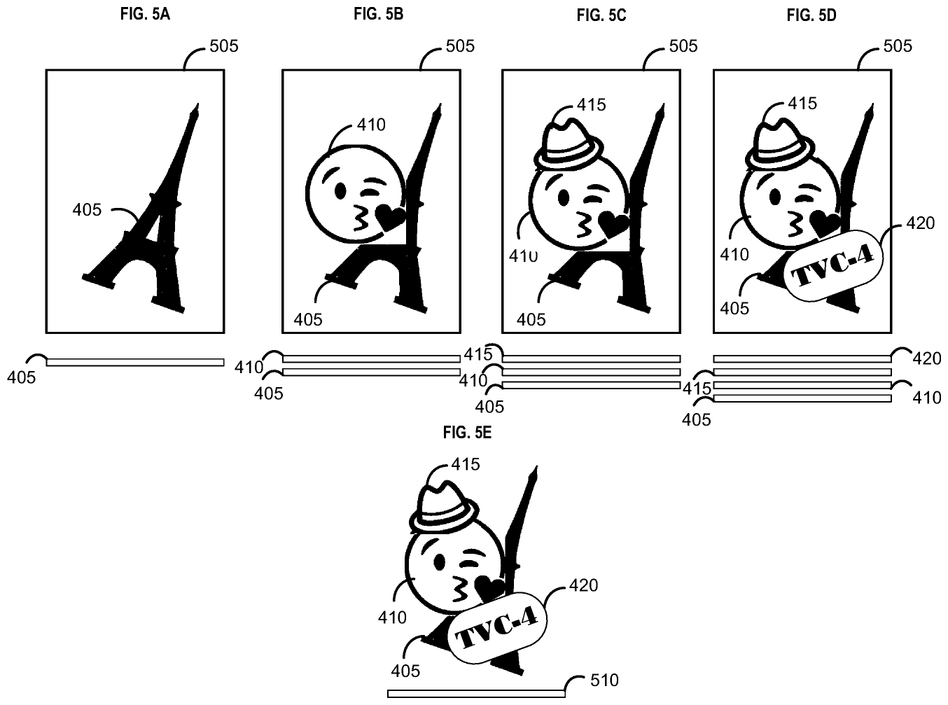

FIGS. 5A-E show block diagrams of an example method for generating a combined query image 510. The methods described in FIGS. 5A-E may be completed by a computing device (e.g., the first computing device 102 or any other computing device). For example, a computing device (e.g., the first computing device 102) may generate the combined query image 510. For example, the first computing device 102 may generate the combined query image 510. For example, the combined query image may comprise the one or more of the plurality of images 405-420 identified in FIGS. 4A-D. Each of FIGS. 5A-E shows a front elevational view and a bottom elevation view to show the layering effect of images 405-420 included in the combined query image 510. However, layering of images is just one example for how the images 405-420 may be combined. As discussed above, in other examples, the images 405-420 may be positioned adjacent to one-another in the combined query image and their positioning may or may not be based on priority of the associated attributes 320-390. For example, the images 405-420 may be positioned adjacent to one-another in order of the word or phrase 215-255 associated with the particular image in the request for content 210.

For example, the first computing device 102 may generate the combined query image 510 by layering one image on top of another image until all of the images are included in the combined query image 510. For example, the first computing device 102 may layer the images 405-420 based on the priority of the attribute 320-390 associated with each image 405-420. For example, the first computing device 102 may determine that the attribute “channel” 340 is the highest priority attribute for which the word or phrase 215-255 in the request for content 210 was associated and may assign the image 420 associated with the phrase “TVC-4” to layer one (e.g., the top layer) of the combined query image 510. The first computing device 102 may determine that the attribute “year” 350 is the second highest priority attribute for which the word or phrase 215-255 in the request for content 210 was associated and may assign the image 415 associated with the word “1920's” to layer two (e.g., the layer immediately below the top layer) of the combined query image 510. The first computing device 102 may determine that the attribute “genre” 360 is the third highest priority attribute for which the word or phrase 215-255 in the request for content 210 was associated and may assign the image 410 associated with the word “romantic” to layer three of the combined query image 510. The first computing device 102 may determine that the attribute “location” 370 is the fourth highest priority attribute for which the word or phrase 215-255 in the request for content 210 was associated and may assign the image 405 associated with the word “Paris” to layer four of the combined query image 510. For example, two or more images may appear or technically be on the same layer by offsetting the particular images vertically and/or horizontally from one-another to prevent any overlap between the particular images.

For example, as shown in FIG. 5A, the first computing device 102 may define a boundary 505 (e.g., a boundary perimeter, such as a boundary box) within which each of the plurality of images 405-420 to be included in the combined query image 510 must be fit within. For example, the first computing device 102 may reduce or enlarge one or more of the plurality of images 405-420 to be included in the combined query image in order to fit within the boundary 505 or the boundary 505 may cause a portion of one or more of the plurality of images 405-420 to be included in the combined query image 510 to not be shown in the combined query image 510.

For example, the first computing device 102 may first select the lowest priority image (e.g., the first image 405), as the higher priority images may be positioned above (or adjacent) at least a portion of a lower priority image. The first computing device 102 may position the first image 405 such that all or at least a portion of the first image 405 is within the boundary 505. The first computing device 102 may adjust the size, color, orientation, or any other aspect of the first image 405.

For example, as shown in FIG. 5B, the first computing device 102 may select the next lowest priority image (e.g., the second image 410) that is being included in the combined query image 510. The first computing device 102 may position the second image 410 such that all or at least a portion of the second image 410 is within the boundary 505. As can be seen in the bottom elevation view of FIG. 5B, the second image 410 may be positioned above the first image 405 in a layered format. The first computing device 102 may adjust the size, color, orientation, or any other aspect of the first image 405 and/or the second image 410. For example, the first computing device 102 may move, reorient, rotate, and/or resize one or both of the first image 405 and the second image 410 with respect to one-another to reduce the amount of overlap or eliminate the overlap between the first image 405 and the second image 410.

For example, the first computing device 102 may select the next lowest priority image (e.g., the third image 415) that is being included in the combined query image 510. The first computing device 102 may position the third image 415 such that all or at least a portion of the third image 415 is within the boundary 505. As can be seen in the bottom elevation view of FIG. 5C, the third image 415 may be positioned above the second image 410 and the first image 405 in a layered format. The first computing device 102 may adjust the size, color, orientation, or any other aspect of the first image 405, second image 410, and/or third image 415. For example, the first computing device 102 may move, reorient, rotate, and/or resize one or more of the first image 405, the second image 410, or the third image 415 with respect to one-another to reduce the amount of overlap or to eliminate overlap between the first image 405, the second image 410, and/or the third image 415.

For example, the first computing device 102 may select the next lowest priority image (e.g., the fourth image 420) that is being included in the combined query image 510. The first computing device 102 may position the fourth image 420 such that all or at least a portion of the fourth image 420 is within the boundary 505. As can be seen in the bottom elevation view of FIG. 5D, the fourth image 420 may be positioned above the third image 415, the second image 410 and the first image 405 in a layered format. The first computing device 102 may adjust the size, color, orientation, or any other aspect of the first image 405, second image 410, third image 415, and/or fourth image 420. For example, the first computing device 102 may move, reorient, rotate, and/or resize one or more of the first image 405, the second image 410, the third image 415, or the fourth image 420 with respect to one-another to reduce the amount of overlap or to eliminate overlap between the first image 405, the second image 410, the third image 415, and/or the fourth image 420.

The first computing device 102 may also weigh or evaluate each image 405-420 against the context of the request for content 210 and the overall meaning in the request for content 210. For example, the first computing device 102 may reduce the size of images that are less closely associated with the request for content 210 and increase the size of images that are more closely associated with the request for content 210. The weights for adjusting each image 405-420 may be preset or provided and/or adjusted based on user input. For example, the first computing device 102 may limit or prevent overlap of certain portions of images. For example the first computing device 102 may limit or prevent overlap of trademarks or logos (e.g., corporate logos). The first computing device 102 may also enhance certain portions of one or more images 405-420 of the plurality of images to be included in the combined query image 510. For example, the first computing device 102 may enhance facial features in an image (e.g., made bigger, made clearer, made more exaggerated, provided with greater contrast to other background facial colors or features, etc.). The first computing device 102 may also manipulate one or more features of one or more images 405-420 of the plurality of images to be included in the combined query image 510. For example, the first computing device 102 may apply one or more filters to all or a portion of an image, may desaturate the colors of an image, or may manipulate the colors of an image (e.g., to better associate the image with a location, year, or time period included in the request for content 210, to better associate, such as equate, not conflict with, not contrast with, etc., the color of the image with the colors of one or more other images in the combined query image, or to better contrast with the colors of one or more other images in the combined query image 510). As shown in FIG. 5E, the first computing device 102 may “flatten” or combine the layers of images 405-420, or otherwise combine the plurality of images 405-420 once positioned as desired, into a single combined query image 510. The combined query image 510 may be a graphical interchange format (GIF) file image or a joint photographic experts group (JPEG) file image.

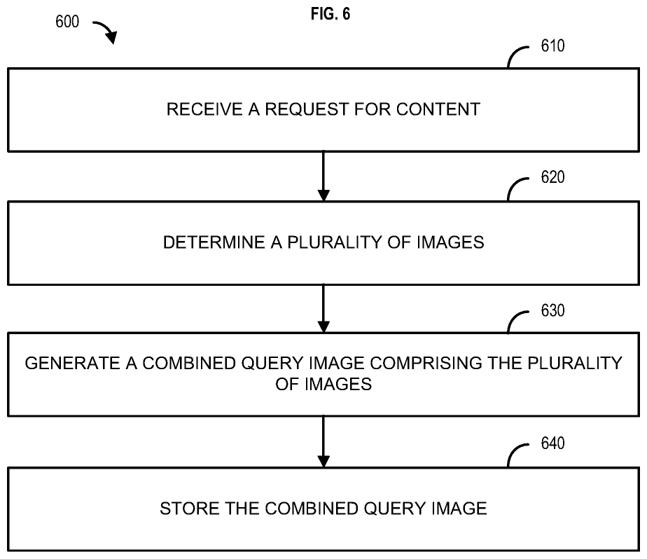

FIG. 6 is a flowchart showing an example method 600 for modifying a request for content (e.g., a search query). The methods described in FIG. 6 may be completed by a computing device (e.g., the first computing device 102 or any other computing device). For example, the modification of the request for content (e.g., the search query for content) may occur between a computing device (e.g., the first computing device 102) and another computing device (e.g., the second computing device 116) via the network 114. The second computing device 116 may be a user device, such as at least one of a client device, a personal computer, computing station, workstation, portable computer, laptop computer, mobile phone, tablet device, remote control, set-top box, smart television, smartphone, smartwatch, smart speaker, a mobile device, or a game system. The network 114 may include one or more network devices, such as at least one of a wireless router, a gateway, an access point, or a node.

At 610, a request for content may be received. For example, the request for content may be received by a computing device (e.g., the first computing device 102 or any other computing device). For example, the content may include audio content, video content, and/or audio/video content. For example, the request for content may be in the form of a search query. The request for content may comprise one or more query elements, such as text (e.g., words and/or phrases), audio content, video content, one or more images, icons, and/or emojis. The request for content may be sent from another computing device (e.g., the second computing device 116). For example, the request for content may be received from the second computing device 116 by the first computing device 102 via the network 114.

The first computing device 102 may parse or separate the request for content into multiple parts. For example, the first computing device 102 may separate each type of element (e.g., text (e.g., words and/or phrases), audio content, video content, one or more images, icons, or emojis) in the request for content from each other type of element. The first computing device 102 may convert each non-text element of the request for content into text. For example, if the request for content includes audio content (e.g., a voice recording), the first computing device 102 (e.g., the speech-to-text module 108) may use speech-to-text software to convert the audio content into text. For example, if the request for content includes video content or one or more icons or images, the first computing device 102 (e.g., the image analyzer module 109) may determine text associated with each of the video content, icon, or image. For example, the first computing device 102 may analyze the video content file or image file for the video content, image, or icon and may determine metadata that describes the video content, image, or icon within the video or image file. The text-based description of the video content, image, or icon within the metadata of the video or image file may be used as the converted text for the video content, image, or icon. For example, if the video content, image, or icon does not include metadata that provides a text-based description of the video content, image, or icon, the first computing device 102 may conduct an internal (e.g., to the first computing device 102) or external (e.g., to the first computing device 102) image search to determine a textual description of the video content, image, or icon. For example, the first computing device 102 may employ an external third-party search module (e.g., search engine) to review the video content, image, or icon and provide one or more options for a textual description of the video content, image, or icon. For example, the first computing device 102 may conduct an internal search by comparing the video content, image, or icon to video content, images, and/or icons stored in the first computing device 102 (e.g., the image database 110) to identify full or partial matches to the video content, image, or icon and associated text describing the image or icon. For example, if the request for content includes one or more emojis, the first computing device 102 may evaluate the emoji and determine the text-based description associated with the emoji. For example, a circular emoji face with a smile and hearts for eyes may be determined by the image analyzer module 109 as being associated with the text “love.”

The first computing device 102 (e.g., the text module 111) may evaluate the text portion of the request for content and parse or separate the text portion of the request for content into one or more words or phrases. For example, the first computing device 102 may compare adjacent words in the text portion of the request for content and determine if those words should be combined into a phrase for image analysis purposes. For example, the first computing device 102 may use n-gram algorithms to determine if one or more adjacent words in the request for content should be combined into a phrase for image analysis purposes. The first computing device 102 may also evaluate the determined text for each of the non-text elements of the request for content to determine if any determined text for a non-text element should be separated or combined into one or more words or phrases in a similar manner.

For example, the first computing device 102 may not determine text associated with one or more non-text elements of the request for content. For example, the first computing device 102 may use one or more of the non-text elements (e.g., an image, an emoji) as one of the images in the combined query image.

At 620, a plurality of images may be determined. For example, the plurality of images may be determined by a computing device (e.g., the first computing device 102 or any other computing device). For example, the plurality of images may be associated with the request for content. For example, each of the plurality of images may be associated with at least a portion of the request for content. For example, the plurality of images may be determined based on the request for content. For example, each of the plurality of images may be determined based on at least a portion of the request for content.

For example, the first computing device 102 (e.g., the text module 111) may determine the one or more words or phrases in the request for content. The first computing device 102 may determine an image to associate to each or a portion of the one or more words or phrases in the request for content. For example, the first computing device 102 may determine which portions of the one or more words or phrases in the request for content to use for corresponding image identification. For example, the first computing device 102 may receive or access one or more attributes for evaluating the one or more words or phrases in the request for content. For example, the one or more attributes may be subject headings or subject types which may indicate the subjects for which images are included, prioritized, and/or given priority in the combined query image. For example, the one or more attributes may comprise a channel or content source identifier, a genre, a location, an actor, an activity, a sport, a year, an era, an emotion, an indication of the request being for a television show or a movie, or the like. The one or more attributes may be a preset group stored in the first computing device 102 or received from the user 118 via the second computing device 116.

The first computing device 102 may compare each word or phrase (and/or each image or emoji) in the request for content to each attribute to determine which of the plurality of words or phrases in the request for content are associated with (e.g., fall within the definition of or would be included in the description of or the grouping of) which attributes. For example, the first computing device 102 may compare each of the one or more words or phrases in the request for content to each attribute of the plurality of attributes to determine if the particular word or phrase is associated with (e.g., falls within the definition of or would be included in the description of or the grouping of) the attribute. For example, one or more words or phrases of the request for content may be associated with each particular attribute. For example, if more than one word or phrase is associated with a particular attribute, then the first computing device 102 may determine images for each of the plurality of words or phrases associated with the particular attribute or may give one of the words or phrases priority over the other (e.g., based on position within the request for content, based on the context of the request for content, etc.) and may only find an image for the prioritized word or phrase associated with the particular attribute.

All or a portion of the one or more attributes may be assigned a priority level with respect to other ones of the one or more attributes. For example, the priority level assigned to the respective one or more attributes may indicate a layer of a plurality of layers of the combined query image for placement of an associated image that corresponds to the portion of the one or more words or phrases in the request for content associated with the particular attribute. For example, the plurality of layers may be a plurality vertically or horizontally oriented layers. For example, each layer may define a planar surface that is parallel to each other planar surface of each other layer. For example, one or more layers of the plurality of layers may be offset from one or more other layers of the plurality of layers in one or more directions parallel to the planar surface of the layer. Offsetting one or more layers may allow for displaying a greater percentage of each image in the combined query image.

For example, the priority level assigned to the respective one or more attributes may indicate a position to place the associated image that corresponds to the portion of the one or more words or phrases in the request for content associated with the particular attribute within the combined query image. For example, the highest priority level attribute that is associated with one or more of the words or phrases in the request for content may be placed at the center of the combined query image. Lesser priority attributes may be positioned at other locations within the area of the combined query image with no or some overlap with other images in the combined query image.

For example, the area for the combined query image may be divided into a grid of image positions within a boundary area for the combined query image and for each of the images identified based on the request for content. Each grid area in the grid of image positions within the boundary area of the combined query image may be associated with a particular priority level of a plurality of priority levels for the attributes. For example, the center of the grid for the combined query image may be associated with the highest priority attribute (e.g., one of the attributes 320-390) for which at least one of the words or phrases (e.g., the words or phrases 215-255) in the request for content is associated. Other areas within the grid may include top left quadrant of the boundary area, top right quadrant of the boundary area, bottom left quadrant of the boundary area, and bottom right quadrant of the boundary area for the combined query image. However, these grid areas are for example purposes only as the grid layout and the priority given to each grid area may be presented in a number of other ways.

For example, the priority level assigned to the respective one or more attributes may indicate an amount of the image that corresponds to the portion of the one or more words or phrases in the request for content associated with the particular attribute that must be viewable in the combined query image. For example, the priority level assigned to the respective one or more attributes may indicate that the image that corresponds to the portion of the one or more words or phrases in the request for content associated with the particular attribute must have a greater percentage viewable in the combined query image than a corresponding image associated with another attribute having a lesser priority level and the percentage may reduce for each corresponding lower priority level. The priority level may be preset for each or a portion of the one or more attributes and/or may be set or modified by the user 118 via the second computing device 116.

For example, the request for content may include the following search query: “Show me romantic movies set in Paris in the 1920's on TVC-4.” The text of the request for content may be been received completely as text or may have included any one or more of text, audio content, video content, images, icons, and/or emojis that were converted to text as described above. The attributes may include the following subject types (in priority order): actor, activity, channel, year, genre, and location, emotion, and tv show/movie. The attributes provided are for example purposes only as additional attributes and/or the elimination of some provided attributes and/or the addition of other attributes may be provided for in other examples. As discussed herein, the priority and types of attributes may be a preset feature or provided or modified by the user 118 via the second computing device 116. The first computing device 102 may determine words or phrases (or optionally images or emojis) in the request for content that are associated with the particular attributes. For example, the first computing device 102 may determine that there are no words or phrases (or optionally images or emojis) in the request for content that are associated with the attributes actor, activity and emotion. The first computing device 102 may determine that the phrase “TVC-4” is associated with (e.g., falls within the subject matter of) the attribute channel. The first computing device 102 may determine that the word “1920's” is associated with (e.g., falls within the subject matter of) the attribute year. The first computing device 102 may determine that the word “romantic” is associated with (e.g., falls within the subject matter of) the attribute genre. The first computing device 102 may determine that the word “Paris” is associated with (e.g., falls within the subject matter of) the attribute location. The first computing device 102 may determine that the word “movies” is associated with (e.g., falls within the subject matter of) the attribute tv show/movie. The remaining portions of the request for content, “show,” “me,” “set,” “in,” “in,” “the,” and “on” may be determined by the first computing device 102 to not be associated with any attribute. The first computing device 102 may determine to not seek images associated with these words or phrases for the combined query image. Alternatively, the first computing device 102 may determine to seek images for one or more of these words or phrases and the priority of the particular word or phrase may be null or less than the lowest priority attribute for which the word or phrase in the request for content was associated.

The first computing device 102 may determine that the attribute “channel” is the highest priority attribute for which the word or phrase in the request for content was associated and may assign an image associate with the word or phrase to layer one of the combined query image. The first computing device 102 may determine that the attribute “year” is the second highest priority attribute for which the word or phrase in the request for content was associated and may assign an image associated with the word or phrase to layer two of the combined query image. The first computing device 102 may determine that the attribute “genre” is the third highest priority attribute for which the word or phrase in the request for content was associated and may assign an image associated with the word or phrase to layer three of the combined query image. The first computing device 102 may determine that the attribute “location” is the fourth highest priority attribute for which the word or phrase in the request for content was associated and may assign an image associated with the word or phrase to layer four of the combined query image. The first computing device 102 may determine that the attribute “tv show/movie” is the fifth highest priority attribute for which the word or phrase in the request for content was associated and may assign an image associated with the word or phrase to layer five of the combined query image.

For example, the first computing device 102 may determine that a quantity of images threshold exists for the combined query image and may compare the number of potential images in the combined query image (e.g., based on the number of attributes associated with one or more words or phrases in the request for content and/or additional words or phrases in the content for which images may be identified) to the quantity of images threshold to determine if the quantity of images threshold is satisfied. For example, if the quantity of images threshold is four and the example above includes five attributes associated with one or more words or phrases of the request for content (e.g., channel, year, genre, location, and tv show/movie), the first computing device 102 may determine that the quantity of images threshold is satisfied (e.g., the quantity of images is greater than or greater than or equal to the quantity of images threshold). The first computing device 102 may limit or reduce the quantity of images to be included in the combined query image to an amount that does not satisfy the quantity of images threshold. For example, the first computing device 102 may limit the quantity of images to be included in the combined query image to the quantity of images that does not satisfy the quantity of images threshold and is associated with the highest priority attributes (e.g., the images associated with the lower priority attributes or with words or phrases in the request for content that are not associated with an attribute would not be included in the combined query image). In the example discussed above, with a quantity of images threshold of four, the images associated with the attributes channel, year, genre, and location would be included in the combined query image (as the quantity four in this example does not satisfy the quantity of images threshold of being greater than a quantity of four images) but an image associated with the attribute tv show/movie would not be included in the combined query image because the attribute tv show/movie has a lower priority level than each of channel, year, genre, and location.

For example, the first computing device 102 may determine an image to associate to each or a portion of the one or more words or phrases in the request for content. For example, the first computing device 102 may determine an image to associate with each of the one or more words or phrases associated with one of the plurality of attributes. For example, the first computing device 102 may determine an image to associate with a portion of the words or phrases associated with one of the plurality of attributes (e.g., due to the quantity of images satisfying a quantity of images threshold). For example, the first computing device 102 may determine an image to associate with one or more of the one or more words or phrases in the request for content that are not associated with (e.g., does not fall within the definition of or would not be included in the description of or the grouping of) any of the plurality of attributes. For example, the first computing device 102 may determine an image to associate with a particular word or phrase based on an internal (e.g., to the first computing device 102) or external (e.g., to the first computing device 102) image search.

For example, in an internal image search, the first computing device 102 may compare each word or phrase in the request for content to a library of images stored in the first computing device 102 (e.g., the image database 110 or another portion of the first computing device 102). For example, the first computing device 102 may identify and select a matching image or closest matching from a plurality of possible matching images in the first computing device 102. For example, each image in the first computing device 102 may include a textual description of the corresponding image. For example, the textual description for each corresponding image may be included in the metadata for the respective image or otherwise associated with the respective image (e.g., table of image data, title of image, etc.). The first computing device 102 may compare the corresponding word or phrase in the request for content to the textual description for each image in the first computing device 102 to identify the one or more matching images. For example, the matching one or more images may be determined based on a threshold percentage of words in the respective word or phrase matching the textual description of the corresponding image being satisfied. The image selected to be associated with the respective word or phrase from the request for content may be the image with the highest percentage match. If multiple images match (e.g., match the same percentage of) the particular word or phrase from the request for content, any of the matching images (e.g., images matching the same level or percentage of the word or phrase from the request for content) may be selected and associated with the particular word or phrase from the request for content.

For example, in an external image search, the first computing device 102 may submit a search query comprising the particular word or phrase of the one or more words or phrases from the request for content to a third-party search module via a network (e.g., via the network 114). The first computing device 102 may receive, via the network 114, one or more image results from the third-party search module. The first computing device 102 may select one or more of the image results to be associated with the particular word or phrase from the request for content. For example, the first computing device 102 may select the first image result to associate with the particular word or phrase from the request for content. For example, the first computing device 102 may select an image result from the one or more image results that best matches the context of the request for content or is properly sized and shaped for the combined query image.

With reference to the earlier example, the first computing device 102 may determine a first image associated with the phrase “TVC-4,” which is associated with the attribute “channel”. For example, the first image may comprise a logo for “TVC-4”, the number 4, or another image associated with “TVC-4”. For example, the first computing device 102 may determine a second image associated with the word “1920's,” which is associated with the attribute “year”. For example, the second image may comprise a graphical representation of the “1920's,” such as an item associated with the “1920's” (e.g., a style of hat or clothing, or product or service available during that year or time period), a designation of the “1920's,” (e.g., a textual representation of the 1920's, a nickname for that time period, such as the “roaring twenties,” etc.), people or characters associated with the “1920's” (e.g., famous people, presidents, sports figures, etc.), and/or a graphical adjustment associated with the “1920's” (e.g., black and white images, dimmed lighting and images (associated with industrialization), etc.). For example, the first computing device 102 may determine a third image associated with the word “romantic,” which is associated with the attribute “genre”. For example, the third image may comprise an emoji kissing with a heart, a heart, and/or other images associated with the romance genre. For example, the first computing device 102 may determine a fourth image associated with the word “Paris,” which is associated with the attribute “location”. For example, the fourth image may comprise a famous building associated with the location (e.g., the Eifel Tower, the Louvre, Notre Dame Cathedral), a textual representation of the location, famous people from the location, foods associated with the location, sports associated with the location, etc. As discussed above, for example, the first computing device 102 may not determine an image associated with the word “movies,” which is associated with the attribute “tv show/movie” because the quantity of images threshold for the combined query image may be satisfied. Further, the first computing device 102 may not determine an image associated with the words “show,” “me,” “set,” “in,” “in,” “the,” and “on” from the request for content, because these words are not associated with any one of the plurality of attributes, are not keywords or descriptive words within the request for content, and/or are unlikely to be associated with images that can be identified and included in the combined query image.

At 630, a combined image query may be generated. For example, the combined image query may be generated by a computing device (e.g., the first computing device 102, such as the image generator 112, or any other computing device). The combined query image may be a graphical image comprising all or a portion of the plurality of images determined and/or selected as being associated with one or more words or phrases in the request for content. For example, the combined query image may comprise each image selected and associated with the word or phrase of the request for content and included in the plurality of images associated with the request for content.

For example, some images of the plurality of images selected or determined to be associated with one or more of the words or phrases in the request for content may be removed or left out of the combined query image. For example, some of the images may be left out of the combined query image because the particular word or phrase in the request for content is not associated with (e.g., falls within the definition of or would be included in the description of or the grouping of) one or more attributes of the plurality of attributes.

For example, the combined query image may comprise only a portion of the images selected and associated with the word or phrase of the request for content and included in the plurality of images associated with the request for content. For example, some images of the plurality of images may not be included because the total quantity of images associated with the one or more words or phrases identified from the request for content (e.g., including the text, text derived from audio content, and/or text derived from video content, images, icons, or emojis in the request for content) satisfies a threshold quantity of images (e.g., is greater than or greater than or equal to the threshold quantity of images).

For example, some images of the plurality of images may not be included in the combined query image based on the size and/or shape of the particular image and/or based on the amount (e.g., percentage) of the particular image being viewable in the combined query image not satisfying an image presentation threshold (e.g., less than or less than or equal to the image presentation threshold). For example, if only a portion of an image may be included in the combined query image (e.g., due to size, amount of detail, color contrasting, etc.) the first computing device 102 may compare the amount of the image (e.g., percentage of the image) that may be included in the combined query image to the image presentation threshold to determine if the image presentation threshold is satisfied (e.g., if the percentage of the image to be included is greater than or greater than or equal to the image presentation threshold). If the image presentation threshold is not satisfied (e.g., the percentage of the image to be included in the combined query image is less than or less than or equal to the image presentation threshold) then the first computing device 102 may determine to not include the image in the combined query image. For example, if the portion of the image satisfies the image presentation threshold, then the first computing device 102 may determine to include the image in the combined query image.

The first computing device 102 may generate the combined query image. For example, the first computing device 102 may define a boundary (e.g., a boundary perimeter, such as a boundary box) within which each of the plurality of images to be included in the combined query image must be within. For example, the first computing device 102 may reduce or enlarge one or more of the plurality of images to be included in the combined query image in order to fit within the boundary or the boundary may cause a portion of one or more of the plurality of images to be included in the combined query image to not be shown in the combined query image. For example, the first computing device 102 may determine the position of at least one image of the plurality of images associated with the request for content, based on the priority for the at least one image of the plurality of images to be included in the combined query image For example, the first computing device 102 may determine the position or placement of the plurality of images based on priority (e.g., based on the priority of each of the plurality of attributes associated with one of the images of the plurality of images, based on the assigned layer for the particular attribute, which may be based the priority of each of the plurality of attributes, or based on another method designed to combine the plurality of images into a single combined query image).

For example, the first computing device 102 may determine a layer level for each image of at least a portion of the plurality of images. For example, the priority of each attribute may be associated with a corresponding layer for placement of an image associated with the particular attribute and one or more of the words or phrases in the request for content. For example, the priority level assigned to the respective one or more of the plurality of attributes may indicate a position (e.g., lateral, vertical, coordinates, etc.) (e.g., a position priority) to place the associated image that corresponds to the portion of the one or more words or phrases in the request for content associated with the particular attribute within the combined query image. For example, the priority level assigned to the respective one or more of the plurality of attributes may indicate an amount of the image that corresponds to the portion of the one or more words or phrases in the request for content associated with the particular attribute that must be viewable in the combined query image. For example, the priority level assigned to the respective one or more of the plurality of attributes may indicate that the image that corresponds to the portion of the one or more words or phrases in the request for content associated with the particular attribute must have a greater percentage viewable in the combined query image than a corresponding image associated with another attribute having a lesser priority level.

For example, the first computing device 102 may first select the lowest priority image or an image without any priority level that is being included, as the higher priority images may be positioned above (or adjacent) a portion of a lower priority image. The first computing device 102 may position the first image (e.g., first image 405) such that all or at least a portion of the first image is within the boundary. The first computing device 102 may adjust the size, color, orientation, or any other aspect of the first image.

For example, the first computing device 102 may select the next lowest priority image or another image without any priority level that is being included in the combined query image. The first computing device 102 may position the second image (e.g., the second image 410) such that all or at least a portion of the second image is within the boundary. The first computing device 102 may adjust the size, color, orientation, or any other aspect of the first image and/or the second image. For example, the first computing device 102 may move, reorient, rotate, and/or resize one or both of the first image and the second image with respect to one-another to reduce the amount of overlap between the first image and the second image.

For example, the first computing device 102 may select the next lowest priority image that is being included in the combined query image. The first computing device 102 may position the third image (e.g., the third image 415) such that all or at least a portion of the third image is within the boundary. The first computing device 102 may adjust the size, color, orientation, or any other aspect of the first image, second image and/or third image. For example, the first computing device 102 may move, reorient, rotate, and/or resize one or more of the first image, the second image, or the third image with respect to one-another to reduce the amount of overlap between the first image, the second image, and the third image.

For example, the first computing device 102 may select the next lowest priority image that is being included in the combined query image (e.g., the highest priority image). The first computing device 102 may position the fourth image (e.g., the fourth image 420) such that all or at least a portion of the fourth image is within the boundary. The first computing device 102 may adjust the size, color, orientation, or any other aspect of the first image, second image, third image, and/or fourth image. For example, the first computing device 102 may move, reorient, rotate, and/or resize one or more of the first image, the second image, the third image, or the fourth image with respect to one-another to reduce the amount of overlap between the first image, the second image, the third image, and the fourth image.

The first computing device 102 may also weigh or evaluate each image (e.g., images 405-420) against the context of the request for content and the overall meaning in the request for content. For example, the first computing device 102 may reduce the size of images that are less closely associated with the request for content and increase the size of images that are more closely associated with the request for content. For example, the first computing device 102 may limit or prevent overlap of certain portions of images. For example the first computing device 102 may limit or prevent overlap of certain portions of an image or certain features within an image, such as trademarks or logos (e.g., corporate logos). The first computing device 102 may also enhance certain portions of one or more images of the plurality of images to be included in the combined query image. For example, the first computing device 102 may enhance facial features in an image (e.g., make bigger, make clearer, make more exaggerated, provide with greater or lesser contrast to other background facial colors or features, etc.). The first computing device 102 may also manipulate one or more features of one or more images of the plurality of images to be included in the combined query image. For example, the first computing device 102 may apply one or more filters to all or a portion of an image, may desaturate the colors of an image, or may manipulate the colors of an image (e.g., to better associate the image with a location, year, or time period included in the request for content; to better associate, such as equate, not conflict with, not contrast with, etc., the color of the image with the colors of one or more other images in the combined query image; or to better contrast with the colors of one or more other images in the combined query image). The first computing device 102 may “flatten” or combine the layers of images, or otherwise combine the plurality of images once positioned as desired, into a single combined query image. The combined query image may be a graphical interchange format (GIF) file image or a joint photographic experts group (JPEG) file image.

The first computing device 102 may append metadata to the combined query image. For example, the first computing device 102 may append metadata to a title or description of the combined query image. For example, the metadata may comprise (or be indicative of) the request for content (e.g., the request for content 210 sent by the second computing device 116). For example, the metadata may comprise an index of the components of the combined query image, such as a description of each of the plurality of images in the combined query image, the one or more words or phrases of the request for content the particular image is associated with, and/or the attribute the image is associated with.

At 640, the combined query image (e.g., the combined query image 510) may be stored for later use. For example, the combined query image may be stored by a computing device (e.g., the first computing device 102, the second computing device 116, or any other computing device). For example, the first computing device 102 may store the combined query image (e.g., in the query database 113). For example, the combined query image may be stored in a table of the first computing device 102. The combined query image may be associated with one or more identifiers of a user (e.g., a user name, an email address, a phone number, an address associated with the second computing device 116 such as a MAC address, a network address, etc.). The one or more user identifiers may be stored in the table of the first computing device 102 with the associated combined query image. For example, multiple combined query images may be associated with the one or more user identifiers of the user 118 in the first computing device 102.

For example, the combined query image may be stored in the second computing device 116 associated with the user 118. For example, the second computing device 116 may be the same computing device that sent the request for content. For example, the first computing device 102 may send the combined query image to the second computing device 116 associated with the user 118. The combined query image may be sent or otherwise transmitted to the second computing device 116 via the network 114 or another network. The particular second computing device 116 may receive the combined query image and store the combined query image in memory of the particular second computing device 116.

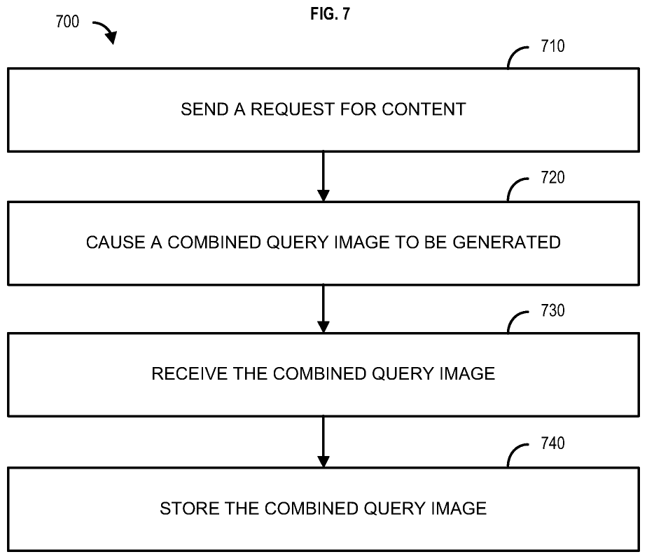

FIG. 7 shows a flowchart of an example method 700 for causing modification of the request for content (e.g., the request for content 210). The methods described in FIG. 7 may be completed by a computing device (e.g., the second computing device 116 or any other computing device). For example, causing modification of the request for content may occur between a computing device (e.g., the second computing device 116) and another computing device (e.g., the first computing device 102). For example, causing modification of the request for content may occur based on communications between the second computing device 116 and the first computing device 102 via a network (e.g., the network 114).

At 710, a request for content may be sent. For example, the request for content (e.g., the request for content 210) may be sent by a computing device (e.g., the second computing device 116 or any other computing device). For example, the request for content may be or include a search query. The request for content may comprise one or more query elements. The one or more query elements may comprise any one or more of text (e.g., one or more words and/or phrases), audio content (e.g., speech), video content, one or more images, icons, or emojis. The request for content may be sent or otherwise transmitted from the second computing device 116 to the first computing device 102 via a network, such as the network 114. The requested content may comprise one or more of audio content, video content, or audio/video content.

At 720, a combined query image may be caused to be generated. For example, a computing device (e.g., the second computing device 116 or any other computing device) may cause the combined query image (e.g., the combined query image 510) to be generated. For example, the second computing device 116 may cause the combined query image to be generated based on sending the request for content. For example, the second computing device 116 may cause the combined query image to be generated based on the request for content. For example, the second computing device 116 may cause the combined query image to be generated based on sending the request for content to the first computing device 102 or another computing device. For example, the second computing device 116 may cause the combined query image to be generated based on a separate request made via the second computing device 116. For example, the separate request may be associated with the request for content. For example, the separate request may be a request to create the combined query image based on a previously sent or transmitted request for content. For example, the second computing device 116 may cause the combined query image to be generated based on the first computing device 102 receiving the request for content from the second computing device 116.

The combined query image may comprise one or more images associated with the request for content. For example, the combined query image may comprises one or more images derived from, determined based on, selected, and/or identified based on one or more words or phrases associated with (e.g., included in or derived from) the request for content. For example, a method for determining the one or more images to include in the combined query image and how to construct the combined query image may be substantially as described herein with regard to FIGS. 2-6 and the associated description.

At 730, a combined query image may be received. For example, the combined query image may be received by a computing device (e.g., the second computing device 116 or any other computing device). For example, the second computing device 116 may receive the combined query image from the first computing device 102 or another computing device via the network 114 or another network. For example, the second computing device 116 may receive the combined query image based on the request for content or based on another request (e.g., a request to generate the combined query image). For example, the second computing device 116 may receive the combined query image in the form of a JPEG or GIF file.

At 740, the combined query image may be stored. For example, the combined query image may be stored by a computing device (e.g., the second computing device 116 or any other computing device). For example, the combined query image may be stored in the second computing device 116 associated with the user 118 that sent the request for content. The second computing device 116 may receive the combined query image and store the combined query image in memory of the second computing device 116. The second computing device 116 may store the combined query image for subsequent use as another request for content. For example, the user 118 via the second computing device 116, may subsequently send the combined query image to the first computing device 102 or another computing device to represent a search query for content (e.g., the request for content). For example, the second computing device 116 may subsequently send the combined query image to another computing device (e.g., another user device). The other computing device may be associated with the user 118 or another unrelated user. The other computing device receiving the combined query image, may subsequently send the combined query image as another request for content. In such a manner, the second computing device 116 (and the user 118 associated therewith) may share preferred search queries in the form of a single image with other computing devices (and other users associated therewith). Further, the single image may include multiple embedded images associated with the original request for content, such that the imagery of the one or more embedded images in the combined query image provides a visual indication of the contents of the request for content associated with the combined query image.

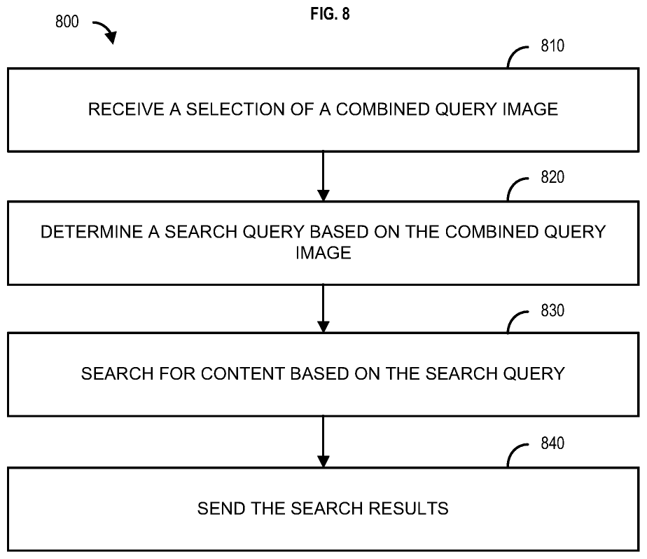

FIG. 8 shows a flowchart of an example method 800 for content searching. The methods described in FIG. 8 may be completed by a computing device (e.g., first computing device 102, the second computing device 116, or any other computing device). For example, content searching may occur between a computing device (e.g., the second computing device 116) and another computing device (e.g., the first computing device 102). Content searching may also occur between the first computing device 102 and one or more source of content (e.g., one or more of the content sources 103a-c). For example, conducting a content search and receiving content may occur based on communications between the second computing device 116, the first computing device 102, and/or one or more sources of content via a network (e.g., the network 114).

At 810, a selection of the combined query image may be received. For example, the selection of the combined query image may be received by a computing device (e.g., the first computing device 102, the second computing device 116, or any other computing device). For example, the combined query image may be generated and/or constructed substantially as described in FIGS. 2-6 and the associated description herein. For example, the first computing device 102 may receive a selection of the combined query image from the second computing device 116 via the network 114, or another network. For example, the second computing device 116 may present on a display of the second computing device 116 and/or to the user 118 one or more combined query images associated with (e.g., created based on a prior request for content from the second computing device 116 and/or the user 118 or stored previously at the second computing device 116 or by the user 118) the user 118 and/or the second computing device 116. A selection may be made of one of the combined query images at the second computing device 116 and sent or otherwise transmitted by the second computing device 116 to the first computing device 102. In another example, the second computing device 116 may receive a selection of the combined query image at the second computing device 116 and may subsequently determine a search query associated with the combined query image at the second computing device 116 without sending it to the first computing device 102. For example, the combined query image may be or otherwise comprise a single image that includes multiple embedded images associated with the prior request for content or search query, such that the imagery of the one or more embedded images in the combined query image provide an indication of the contents of the request for content or search query associated with the combined query image.

At 820, a search query may be determined. For example, the search query may be determined by a computing device (e.g., the first computing device 102, the second computing device 116, or any other computing device). For example, the first computing device 102 or the second computing device 116 may determine the search query based on the selected and/or sent/received combined query image. For example, the first computing device 102 and/or the second computing device 116 may determine metadata associated with the selected and/or sent/received combined query image. The first computing device 102 and/or the second computing device 116 may determine, based on the metadata associated with the combined query image, the search query or the request for content associated with the combined query image. For example, the search query may comprise the request for content. For example, the search query may be included in the metadata of the combined query image. For example, the first computing device 102 and/or the second computing device 116 may parse or otherwise determine the search query/request for content from a title, description, or another portion of the metadata for the file of the combined query image.

At 830, a search for content may be conducted based on the search query/request for content associated with (e.g., included in the metadata of the file for) the combined query image. For example, the search for content may be conducted by a computing device (e.g., the first computing device 102, the second computing device 116, or any other computing device). For example, the content may comprise one or more of audio content, video content and/or audio/video content. For example, the content may comprise live, linear content and/or video-on-demand (VOD) content. For example, the search may be an internal search (e.g., searching for content locally stored or otherwise accessible to the first computing device 102 and/or the second computing device 116) and/or an external search (e.g., searching for content external to the first computing device 102 and/or the second computing device 116). Based on the search, the first computing device 102 and/or the second computing device 116 may receive or otherwise identify one or more search results that satisfy the search query/request for content embedded into the file of the combined query image. For example, the first computing device 102 may receive a plurality of search results that satisfy all or a portion of the search query/request for content.

At 840, the search results may be sent to or otherwise caused to be presented or displayed. For example, the search results may be sent to or otherwise caused to be presented or displayed at a computing device (e.g., the second computing device 116 or any other computing device). For example, the first computing device 102 may receive the search results based on the search query/request for content and may send or otherwise transmit all or a portion of the search results to the second computing device 116. The search results may be sent from the first computing device 102 to the second computing device 116 via the network 114 or another network. The second computing device 116 may receive all or a portion of the search results and present, display, or output all or a portion of the search results on a display associated with the second computing device 116. For example, a selection of one of the search results may be received at the second computing device 116. Based on the selection of the one or more search results being received, a request for the content may be sent from the second computing device 116 to the first computing device 102. For example, the first computing device 102 may facilitate providing (e.g., sending) the content associated with the selected one or more search results to the second computing device 116.

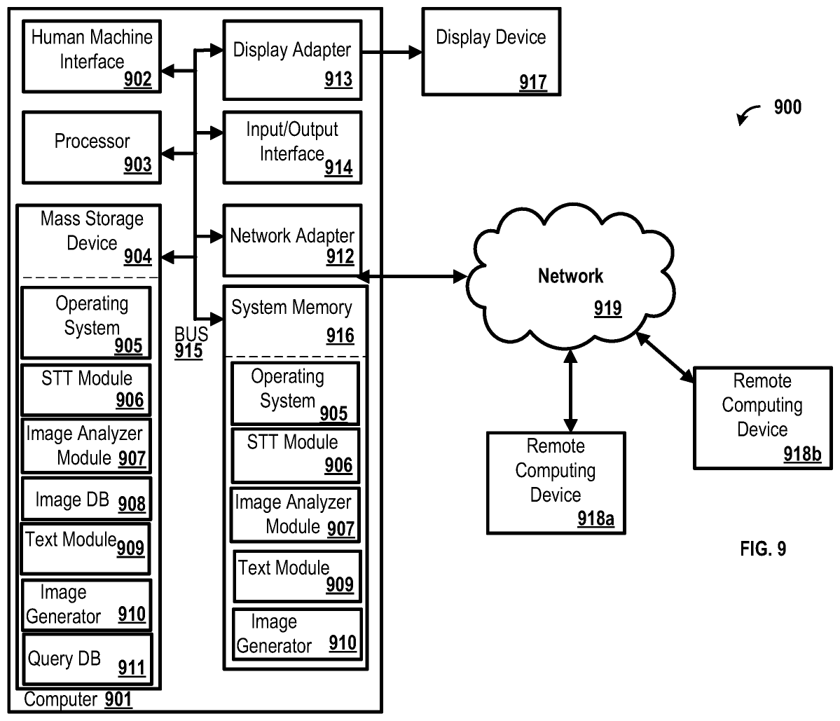

FIG. 9 shows a system 900 for modifying the request for content and conducting content searching. Each of the second computing device 116 and the first computing device 102 (FIG. 1) may be a computer 901 as shown in FIG. 9.

The computer 901 may comprise one or more processors 903, a system memory 916, and a bus 915 that couples various components of the computer 901, including the one or more processors 903 to the system memory 916. In the case of multiple processors 903, the computer 901 may utilize parallel computing.

The bus 915 may comprise one or more of several possible types of bus structures, such as a memory bus, memory controller, a peripheral bus, an accelerated graphics port, and a processor or local bus using any of a variety of bus architectures.

The computer 901 may operate on and/or comprise a variety of computer-readable media (e.g., non-transitory). Computer-readable media may be any available media that is accessible by the computer 901 and includes, non-transitory, volatile and/or non-volatile media, and removable and non-removable media. The system memory 916 has computer-readable media in the form of volatile memory, such as random access memory (RAM), and/or non-volatile memory, such as read-only memory (ROM). The system memory 916 may store data such as image data 908 and query data 911 (not shown) and/or program modules such as an operating system 905, speech-to-text modules 906, image analyzer modules 907, text modules 909 and image generator 910 software that are accessible to and/or are operated on by the one or more processors 903.

The computer 901 may also comprise other removable/non-removable, volatile/non-volatile computer storage media. The mass storage device 904 may provide non-volatile storage of computer code, computer-readable instructions, data structures, program modules, and other data for the computer 901. The mass storage device 904 may be a hard disk, a removable magnetic disk, a removable optical disk, magnetic cassettes or other magnetic storage devices, flash memory cards, CD-ROM, digital versatile disks (DVD) or other optical storage, RAM, ROM, electrically erasable programmable read-only memory (EEPROM), and the like.

Any number of program modules may be stored on the mass storage device 904. The operating system 905, the speech-to-text module 906, the image analyzer module 907, the text module 909, and the image generator 910 software may be stored on the mass storage device 904. One or more of the operating system 905, the speech-to-text module 906, the image analyzer module 907, the text module 909, and the image generator 910 software (or some combination thereof) may comprise program modules. Image data 908 and query data 911 (e.g., historical query data and combined query images) may also be stored on the mass storage device 904. Image data 908 and query data 911 may be stored in any of one or more databases known in the art. The databases may be centralized or distributed across multiple locations within a network 919.

A user may enter commands and information into the computer 901 via an input device (not shown). Such input devices include, but are not limited to, a keyboard, pointing device (e.g., a computer mouse or remote control), a microphone, a joystick, a scanner, tactile input devices such as gloves, and other body coverings, a motion sensor, and the like These and other input devices may be connected to the one or more processors 903 via a human-machine interface 902 that is coupled to the bus 915, but may be connected by other interface and bus structures, such as a parallel port, game port, an IEEE 1394 Port (also known as a Firewire port), a serial port, network adapter 912, and/or a universal serial bus (USB).

A display device 917 may also be connected to the bus 915 via an interface, such as a display adapter 913. It is contemplated that the computer 901 may have more than one display adapter 913 and the computer 901 may have more than one display device 917. A display device 917 may be a monitor, an LCD (Liquid Crystal Display), a light-emitting diode (LED) display, a television, smart lens, smart glass, and/or a projector. In addition to the display device 917, other output peripheral devices may comprise components such as speakers (not shown) and a printer (not shown) which may be connected to the computer 901 via Input/Output Interface 914. Any step and/or result of the methods may be output (or caused to be output) in any form to an output device. Such output may be any form of visual representation, including, but not limited to, textual, graphical, animation, audio, tactile, and the like. The display device 917 and computer 901 may be part of one device, or separate devices.

The computer 901 may operate in a networked environment using logical connections to one or more remote computing devices 918a,b. A remote computing device 918a,b may be a user device (e.g., the second computing device 116), such as a client device, a personal computer, computing station, workstation, portable computer, laptop computer, mobile phone, tablet device, remote control, set-top box, smart television, smartphone, smartwatch, smart speaker, a mobile device, or a game system, and so on. Logical connections between the computer 901 and the remote computing device 918a,b may be made via the network 919, such as a local area network (LAN) and/or a general wide area network (WAN). Such network connections may be through a network adapter 912. A network adapter 912 may be implemented in both wired and wireless environments. Such networking environments are conventional and commonplace in dwellings, offices, enterprise-wide computer networks, intranets, and the Internet.

Application programs and other executable program components such as the operating system 905 are shown herein as discrete blocks, although it is recognized that such programs and components may reside at various times in different storage components of the computing device 901, and are executed by the one or more processors 903 of the computer 901. Any of the disclosed methods may be performed by processor-executable instructions embodied on computer-readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, by a computing device, a request for content;
determining, based on the request for content, a plurality of images; and
generating a combined query image representing the plurality of images and configured for a subsequent request for content.

2. The method of claim 1, wherein the request for content comprises a plurality of elements and wherein determining the plurality of images comprises determining, based on at least a portion of the plurality of elements, the plurality of images.

3. The method of claim 2, wherein the request for content comprises at least one of: at least one word or phrase, an emoji, audio content, an icon, video content, or an image.

4. The method of claim 1, wherein the request for content comprises a plurality of words or phrases.

5. The method of claim 1, further comprising appending, to the combined query image, metadata comprising the request for content.

6. The method of claim 1, wherein the request for content comprises an image, the method further comprising determining, based on the image, text content associated with the image, wherein one of the plurality of images is determined based on the text content.

7. The method of claim 1, wherein generating the combined query image comprises:
determining a priority for each image of the plurality of images; and
positioning, based on the priority for at least one image of the plurality of images, the plurality of images into the combined query image.

8. The method of claim 1, wherein generating the combined query image comprises:
determining a layer level for each image of at least a portion of the plurality of images; and
positioning, based on the layer level for at least one image of the at least the portion of the plurality of images, the plurality of images into the combined query image.

9. The method of claim 1, wherein the request for content comprises a plurality of words or phrases, the method further comprising:
determining a plurality of attributes associated with the request for content, wherein each attribute of the plurality of attributes is associated with at least one word or phrase of the plurality of words or phrases; and
determining, based on the attribute associated with each image of at least a portion of the plurality of images, a location of the respective image of the plurality of images in the combined query image.

10. The method of claim 1, wherein the request for content comprises a search query.

11. A method comprising:
receiving, by a computing device, a search query;
determining, based on the search query, at least one word or phrase;
determining, for at least one of the at least one word or phrase, at least one image associated with the at least one word or phrase; and
generating, based on the at least one image, a query image representing the search query, wherein the query image comprises metadata comprising the search query, and configured for a subsequent search query.

12. The method of claim 11, wherein the search query comprises the at least one word or phrase.

13. The method of claim 11, wherein the search query comprises at least one of: a word, an emoji, audio content, an icon, video content, or an image.

14. The method of claim 11, wherein a portion of the search query comprises an image, the method further comprising:
determining, text content associated with the image; and
determining, based on the text content, a word or phrase associated with the image.

15. The method of claim 11, wherein determining the at least one word or phrase comprises determining a plurality of words or phrases, wherein determining the at least one image comprises determining a plurality of images and wherein generating the query image comprises:
determining a position priority for each image of at least a portion of the plurality of images; and
positioning, based on the position priority for each image of the at least the portion of the plurality of images, the plurality of images into the query image.

16. The method of claim 15, wherein positioning the plurality of images into the query image comprises:
determining a layer level for at least one of the plurality of images; and
layering, based on the layer level for at least one of the plurality of images, the plurality of images into the query image.

17. The method of claim 11, wherein determining the at least one word or phrase comprises determining, based on the search query, a plurality of attributes, wherein each attribute is associated with a different at least one of the at least one word or phrase of the search query.

18. A method comprising:
sending, to a computing device, a request for content; and
in response to the request, receiving, from the computing device, a combined query image representing a plurality of images associated with the request for content and configured for a subsequent request for content.

19. The method of claim 18, wherein the combined query image further comprises metadata indicative of the request for content.

20. The method of claim 18, further comprising:
sending the combined query image wherein the combined query image causes a search for content associated with the combined query image.
